(19) United States
(12) Patent Application Publication
(10) Pub. No.: US 2012/0310923 A1
(43) Pub. Date: Dec. 6, 2012

(54) SYSTEM AND METHOD OF GENERATING A HUMAN-READABLE DATA SYNOPSIS

(76) Inventor: Bradley Alexander Ross, Toronto (CA)

(21) Appl. No.: 13/309,154

(22) Filed: Dec. 1, 2011

Related U.S. Application Data
(60) Provisional application No. 61/418,555, filed on Dec. 1, 2010.

(51) Int. Cl. G06F 17/30

(52) U.S. Cl. 707/722; 707/E17.018; 707/E17.061

(57) ABSTRACT

A method of generating a human-readable data synopsis involves a computer receiving data comprising demographic and/or consumer behavioural data attributes; and forming data aggregations by querying the received data with at least a first query and a second query. At least one of the data sources comprises geographic data associated with the data attributes. The queries each include a common data attribute criterion that queries the data attributes, and a respective geographic criterion that queries the geographic data. The geographic criterion of the first query defines a different geographic region than that of the second query. The computer performs an analysis of the data aggregations by applying the results of the queries as inputs to a pre-defined logic function, and evaluating the logic function. On a display device, the computer generates the human-readable synopsis by applying a result of the data aggregation analysis as input to a pre-defined report template.

### RELATED APPLICATIONS

This patent application claims the benefit of the filing date of U.S. Patent Application No. 61/418,555, filed Dec. 1, 2010.

### FIELD

This patent application relates to a system and method of generating a human-readable data synopsis and, in particular, to a method of generating a human-readable report of analyzed data.

### BACKGROUND

Databases that contain measured and recorded data representing various consumer and household attributes are typically maintained by data providers including government bodies, service providers, and market research companies. The data may be obtained by a data provider by observing consumer activity or by requesting information from the consumer. Examples of commercially available consumer and household attributes that may be stored in databases include demographic attributes (such as age, income, ethnicity, etc.), behavioural attributes (such as consumer preferences, household values, spending patterns, etc.), citizen and property attributes (such as housing values, population, etc.), other survey data as provided by survey and market research companies, and attributes available through Government agencies.

Data stored in the databases can be linked to a physical geographic location such as a household address, zip code (for addresses in the United States of America), postal code (for addresses in Canada), and other levels of geographic classification herein referred to as “Known Geographic Locations”. However, generating useful reports from the data is difficult.

### SUMMARY

This patent application describes a system and method to automatically generate a human-readable synopsis of geographically-associated demographic data attributes and consumer behavioural data attributes.

The method of generating a human-readable data synopsis may involve a computer receiving data from a plurality of data sources comprising demographic data attributes and/or consumer behavioural data attributes; and the computer forming data aggregations by querying the received data with at least a first query and a second query. At least one of the data sources comprises geographic data associated with the demographic data attributes and/or consumer behavioural data attributes.

The first and second queries each include a common data attribute criterion and a respective geographic criterion. The data attribute criterion queries the demographic and/or consumer behavioural data attributes, and the geographic criteria queries the geographic data. The geographic criterion of the first query defines a different geographic region than the geographic criterion of the second query.

The computer performs an analysis of the data aggregations by applying a result of the first query and a result of the second query as inputs to a pre-defined logic function, and evaluating the logic function. On a display device, the computer generates a human-readable synopsis of the received data by applying a result of the data aggregation analysis as an input to a pre-defined report template.

The computer system may include a data aggregator, a logic analyzer, and a report engine. The data aggregator may be configured to receive, from a plurality of data sources, data comprising demographic data attributes and/or consumer behavioural data attributes, and to form data aggregations by querying the received data with at least a first query and a second query. At least one of the data sources comprises geographic data that is associated with the demographic data attributes and/or consumer behavioural data attributes. The first and second queries each include a common data attribute criterion and a respective geographic criterion. The data attribute criterion queries the demographic and/or consumer behavioural data attributes, and the geographic criteria queries the geographic data. The geographic criterion of the first query defines a different geographic region than the geographic criterion of the second query.

The logic analyzer may be configured to perform an analysis of the data aggregations by applying a result of the first query and a result of the second query as inputs to a pre-defined logic function, and evaluating the logic function. The report engine may be configured to generate and display on a display device a human-readable synopsis of the received data by applying a result of the data aggregation analysis as an input to a pre-defined report template.

### BRIEF DESCRIPTION OF THE DRAWINGS

The system and method of automatically generating a human-readable synopsis will now be described, by way of example, with reference to the accompanying drawings, in which:

FIG. 1 is a schematic diagram of the computer system that implements the method;

FIG. 2 is a flow chart depicting an implementation of the method as performed by the computer system of FIG. 1;

FIG. 3 is a flow chart depicting another implementation of the method;

FIG. 4 is a top plan view of a map showing a geographic region defined by lines connecting the points labeled E, F, and G, including the geographic points A, B, and C within the defined geographic region;

FIG. 5 is a data table showing how geographic data points may be expressed for use by the computer system of FIG. 1;

FIG. 6 is a data table showing how geographic polygon data may be expressed for use by the computer system of FIG. 1;

FIG. 7 is a data table providing examples of predefined logic processes for evaluation by the computer system of FIG. 1, and examples of logic scenarios captured by the logic processes; and

FIG. 8 is a screen view of a pre-defined report template layout for use by the computer system of FIG. 1.

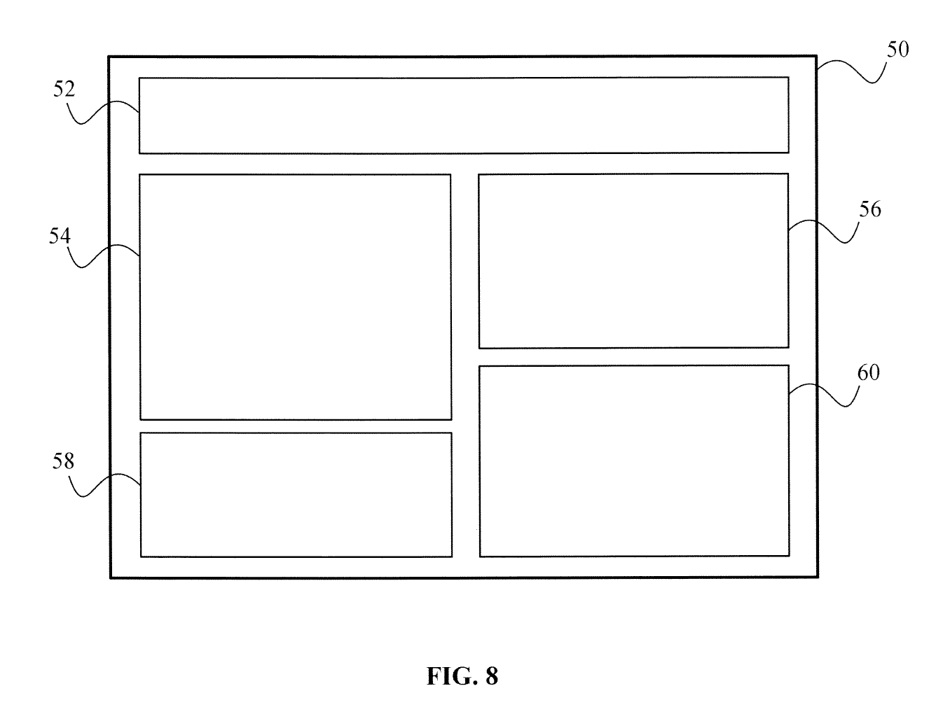

### DETAILED DESCRIPTION

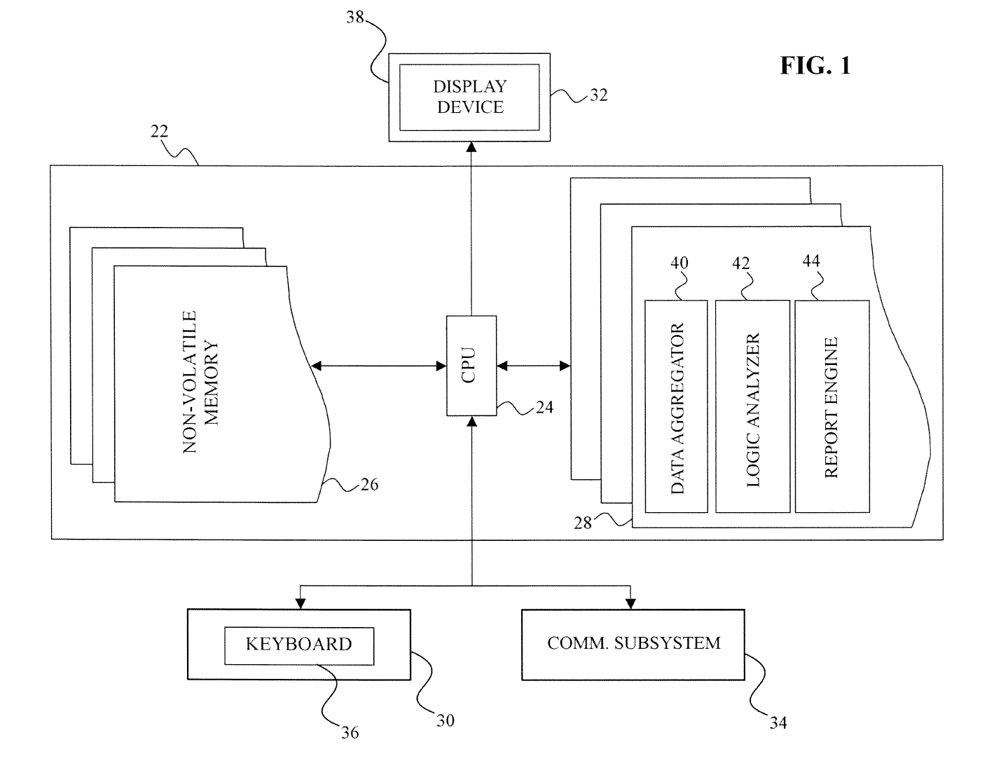

Referring to FIG. 1, there is shown a sample computer system 20 that includes a data processor 22, an input/output subsystem 30, a display subsystem 32, and a communications system 34. The data processor 22 controls the overall operation of the computer system 20, and may comprises a microprocessor 24 in communication with non-volatile memory 26 and volatile memory (random access memory, or RAM) 28. Either the non-volatile memory 26 or RAM 28 may include computer processing instructions, which when executed by the microprocessor 24, implement an operating system, and computer programs. Alternately, the computer processing instructions may be copied from the non-volatile memory 26 to the RAM 28 upon reset or power-up of the computer system 20, or at any other time when the computer system 20 is powered on, and executed by the microprocessor 24 out of the RAM 28. The non-volatile memory 26 may comprise flash memory, read-only memory, one or more magnetic hard drives or other magnetic or optical media.

The input/output subsystem 30, display subsystem 32, and communications system 34 are each in communication with the data processor 22. The input/output subsystem 30 may comprise a keyboard 36, or other input device for receiving input from a user of the computer system 20. The display subsystem 32 may comprise a display device 38 capable of displaying data or graphics on a display screen (not shown) of the display device 38 in accordance with data received by the display subsystem 32. Through use of the communications subsystem 34, the data processor 22 may communicate with one or more other computer systems or other computing devices either across local or wide area networks, using any wired or wireless network communication protocol.

The operating system of the data processor 22 allows the computer system 20 to operate the display subsystem 32 and the input/output subsystem 30, and to communicate with the communications system 34.

The computer programs of the data processor 22 may include a data aggregator 40, a logic analyzer 42, and a report engine 44. The functions of the data aggregator 40, logic analyzer 42, and report engine 44 will be discussed in greater detail below. However it is sufficient at this point to note that the data aggregator 40 is in communication with the logic analyzer 42 and report engine 44, and may be configured to receive, from a plurality of data sources, data comprising demographic data attributes and/or consumer behavioural data attributes, and to form data aggregations by querying the received data with at least a first query and a second query.

At least one of the data sources may comprise geographic data that is associated with the demographic data attributes and/or consumer behavioural data attributes. The first and second queries may each include a common data attribute criterion and a respective geographic criterion. The data attribute criterion queries the demographic and/or consumer behavioural data attributes, and the geographic criteria queries the geographic data. Preferably, the geographic criterion of the first query defines a different geographic region than the geographic criterion of the second query.

The logic analyzer 42 may be configured to perform an analysis of the data aggregations by applying a result of the first query and a result of the second query as inputs to a pre-defined logic function, and evaluating the logic function. The report engine 44 may be configured to generate and display on a display device a human-readable synopsis of the received data by applying a result of the data aggregation analysis as an input to a pre-defined report template.

The computer programs may further include a list engine (not shown) and/or conversion engine (not shown), each of which also being in communication with the data aggregator 40, logic analyzer 42, and report engine 44. It should also be understood that although the data aggregator 40, logic analyzer 42, report engine 44, list engine, and conversion engine are preferably implemented as a set of computer processing instructions, these modules (or engines) may be implemented entirely or partially in electronics hardware instead, either in one or across many electronics hardware devices.

Invocation of each of the data aggregator 40, logic analyzer 42, and report engine 44 may be initiated by a user having direct physical access to the computer system 20. Preferably, however, invocation of each of the data aggregator 40, logic analyzer 42, and report engine 44 is initiated via a client terminal in communication with the computer system 20 through the communications subsystem 34 over a communications network. A user of the client terminal may command the computer system 20 to invoke each of the data aggregator 40, logic analyzer 42, and report engine 44, and any or all of the results of the execution thereof may be transmitted by the computer system 20 through the communications subsystem 34 over the communications network to the client terminal.

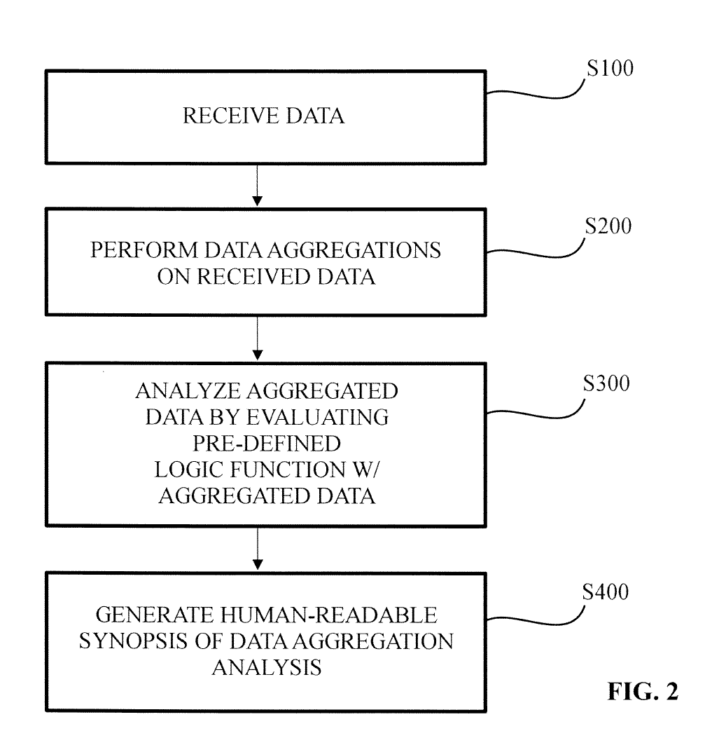

FIG. 2 is a flow chart that depicts, by way of overview, the method implemented in the computer system 20 for providing a human-readable data synopsis. In particular, the method implemented in the computer system 20 processes geographically-associated demographic and behavioural data attributes into a human-readable data synopsis.

At step S100, the computer system 20, and in particular the data aggregator 40, receives data from a plurality of data sources. Each data source may comprise at least one of demographic data attributes and consumer behavioural data attributes. At least one of the data sources may further comprise geographic data associated with the at least one of demographic data attributes and consumer behavioural data attributes. In one implementation, the list engine receive the data instead of the data aggregator 40.

Each data source may comprise one or more databases, and may be accessible to the computer system 20 via the communications subsystem 34, or may be stored in the memory 26, 28. Each database may contain demographic data attributes, consumer behavioural data attributes, geographic data, or combinations thereof. Each data source may be maintained by a user of the computer system 20, a data vendor, or any other party. In the case of a particular data vendor, the data stored in the database may originate from the vendor's own research including sales data, customer preferences, and tenure.

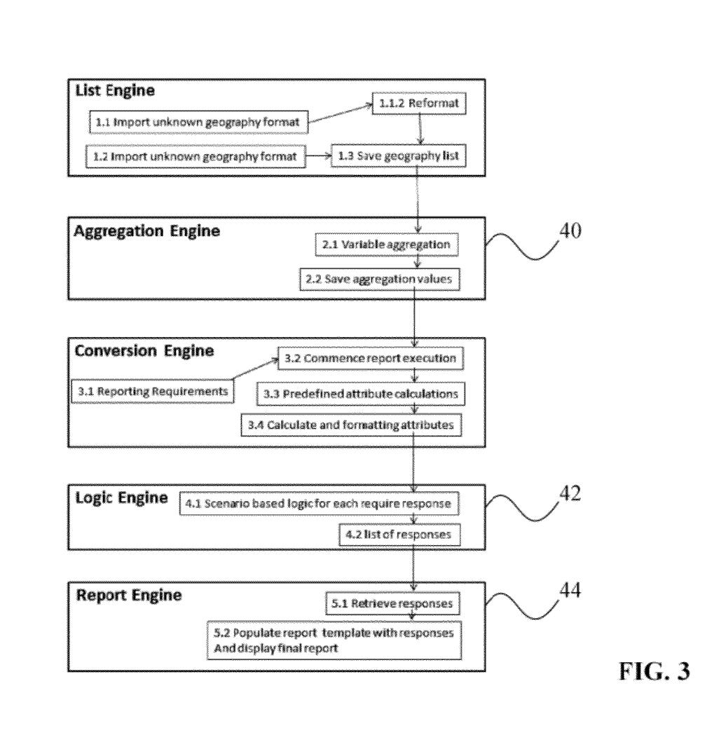

The method implemented by the computer system 20, may be automated whereby the logic analyzer 42 begins performing its pre-defined operations when the data aggregator 40 completes its pre-defined actions (and/or the report engine 44 begins performing its pre-defined operations when the logic analyzer 42 completes its pre-defined actions). Optionally, the computer system 20 may prompt a user, via the display device 38 or by other means, before continuing to the next step of the method. One embodiment of the computer system 20 is depicted in FIG. 3, which also shows an abstracted summary of the data flow between the data aggregator 40, logic analyzer 42, and report engine 44 to produce the human-readable data synopsis (or report).

Optionally, prior to step S100, a user may enter operational parameters into the computer system 20 through the keyboard 36 or other input device. The operational parameters may include identifying the data sources, demographic data attributes, behavioural data attributes, and geographic data for analysis by the computer system 20. The user may import a new data source or select a data source that has already been created on the computer system 20. The user may also be prompted to select a second data source with which to compare any of the data in the initially selected data source. For example, a user may elect to compare the selected data source to data corresponding to the average household of a selected country or region.

The user may also select a pre-defined report template from a list of pre-defined report templates defined by the report engine 44 that the computer system 20 may use to generate the report. The user may not be required to create the user's own report template, or to select the type of analysis to be featured in the report. Each pre-defined report template may be pre-programmed to specify pre-determined analysis criteria dictating what data analysis will be featured in the report.

Once these parameters are selected, the computer system 20 may execute each of the engines 40, 42, 44 in sequential order, providing parameters entered by the user to each engine 40, 42, 44 or providing the output of one or more engines 40, 42, 44 to other engines 40, 42, 44 for further processing. The user may not be required to create database queries, identify objects that appear on a report, or enter any logic statements to be executed by the system as these components of the system and method may be pre-defined.

While the method step S 100 is described with respect to the data aggregator 40 throughout, the list engine may alternatively implement some or all of the functionality of the data aggregator 40 for the purposes of step S 100. Each data source specified by the computer system 20 or the user may be read and analyzed by the data aggregator 40 in order to read the data attributes and into the memory 26, 28. Each record in the database may have associated geographic location data in the same data source. Where the geographic location data is located in another data source, the data aggregator 40 may read the data from that data source as well. The data aggregator 40 may produce a list of all records in the data source that satisfy geographic region search criteria specified by the user or the pre-defined report template. The geographic location data can be saved in different formats in the data sources. For example, the data sources may store a complete mailing address for each data record, a ZIP or postal code, a precise latitude and longitude, or GPS co-ordinates.

However, in one implementation, the data aggregator 40 may be configured to conduct analysis using only one type of measure of geographic location, typically latitude and longitude. In that case, the data aggregator 40 may read all of the records in the database into computer system 20 memory and convert the geographic location for each record to an approximate latitude and longitude using known geographic-location techniques. The data aggregator 40 could then analyze the copy of the data stored in memory 26, 28 or create a file recorded on non-volatile memory 26 for later use by the data aggregator 40.

At step S200, the computer system 20, and in particular the data aggregator 40, forms data aggregations by querying the received data with at least a first query and a second query. The first and second queries each may include a common data attribute criterion and a respective geographic criterion. The data attribute criterion may be used by the data aggregator 40 to query the at least one demographic and consumer behavioural data attributes. The data aggregator 40 may use the geographic criteria to query the geographic data. Preferably, the geographic criterion of the first query defines a different geographic region than the geographic criterion of the second query.

Although only first and second queries are described, any additional number of queries may be possible depending on the data analysis required and pre-defined by the selected pre-defined report template. While the method step 5200 is described with respect to the data aggregator 40 throughout, the list engine may alternatively implement some or all of the functionality of the data aggregator 40 for the purposes of step 5200.

Once the geographic location data is in a format usable by the data aggregator 40, the data aggregator 40 may query the data using the respective geographic criterion and common data attribute criterion to produce data aggregations of all records in the data sources having associated geographic location data that satisfies the respective geographic region search criteria of each query. Preferably, the data attribute criterion is common between the first query and the second query so that data attributes of a common type may be analyzed. For example, the common data attribute criterion may be household income and the respective geographic criterion of each query may define geographic regions of different areas.

In one implementation, the geographic criterion associated with the second query comprises a subset of the geographic criterion associated with the first query. Accordingly, one of the geographic regions may be a subset of or intersect with the other geographic region. In another implementation, the geographic criterion associated with the second query may be entirely geographically distinct from the geographic criterion associated with the first query. It may be preferable that the geographic regions are not identical. For example, geographic criterion for the first query may define a geographic region covering the a city, while the geographic criterion for the second query may define a geographic region covering the state, province, or country where that city is located, or another city, state, province, country or other geographic region. The geographic region search criteria may be input by a user of the computer system 20, or it may be read from a memory 26, 28 pre-defined by the selected report template of the report engine 44.

In another implementation, each of the geographic criteria may comprise at least one of a pair of latitude and longitude co-ordinates, a pair of geographic point and radius distance, and a geographic polygon. Each respective geographic criterion may identify one or more physical locations or regions on Earth that may or may not be continuous geographic regions. Each geographic region may be made up of one or more geographic points (co-ordinates of specific locations on Earth), one or more areas called geographic polygons (three or more points that together describe a specific area on Earth), or a combination of geographic points and polygons. Where a geographic point is provided, a radius around the point may also be provided to determine the size of the geographic region.

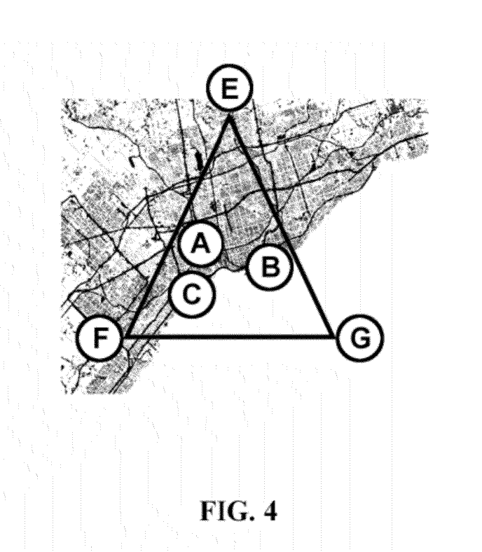

To help visualize this process, FIG. 4 is provided showing a geographic polygon defined by the points E, F, and G as an example of a user generated polygon which may be generated using an online mapping tool. Points A, B, and C represent known geographic locations associated with data source records that are geographically located within the indicated geographic polygon. The data source records corresponding to locations A, B, and C may be saved in memory 26, 28 or to a new database file on no-volatile memory 26 continued or future analysis by the computer system 20. Points E, F, G represent the boundaries of the polygon. Each location may have a defined physical location on Earth represented by latitude and longitude. The highlighted area in FIG. 4 represents the geographic region to be analyzed. A, B, and C may be produced by the data aggregator 40.

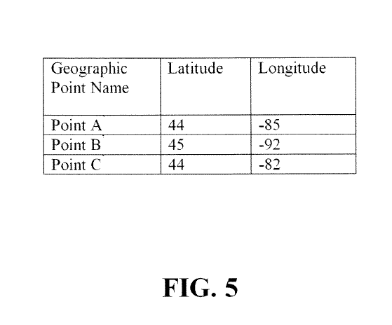

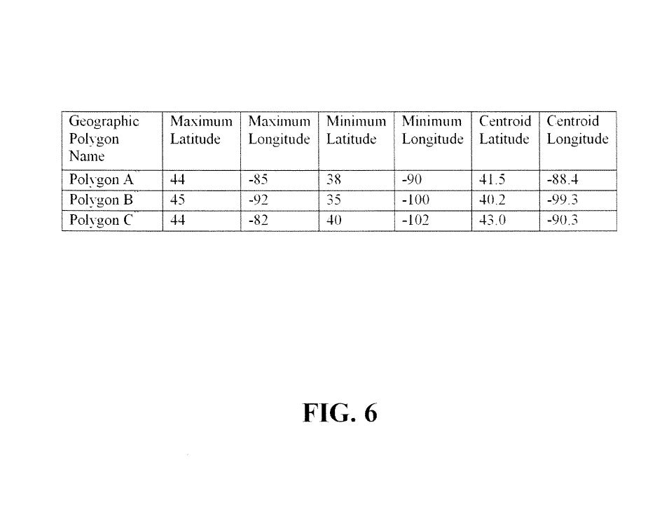

FIG. 5 is an example of how geographic points may be expressed in terms of their respective latitude and longitude. Latitude and longitude in FIG. 5 represent the physical location on Earth of the respective geographic point. FIG. 6 likewise is an example of how geographic polygons may be represented in the list engine by maximum latitude, maximum longitude, minimum latitude, minimum longitude, centroid latitude, and centroid longitude. Accordingly, where at least one of the geographic criteria comprises at least one geographic polygon, the geographic polygon may be defined by a maximum latitude, maximum longitude, minimum latitude, minimum longitude, centroid latitude, and centroid longitude.

Alternatively, a geographic region may also be specified by ZIP or postal code, street, state or province, city, or Country. The data aggregator 40 may read from a data source in memory 24, 28 consumer ZIP codes, postal codes, street addresses, states, provinces, cities, and countries, geographic trade area for a particular vendor, and other identifiable geographic regions associating corresponding geographic points or polygons for each of those identifiable geographic regions. When one of the identifiable geographic regions is submitted to the data aggregator 40, the data aggregator 40 may then lookup the known geographic points or polygons for the identified geographic region in order to conduct the requested analysis described previously.

The records produced by the data aggregator 40 may be stored in memory 26, 28 and further read from memory 26, 28 by the data aggregator 40. The data aggregator 40 may group together or produce a sum of each data attribute contained in database records produced by the data aggregator 40, and output aggregation data that reflect the results of the aggregation process.

In one implementation, the common data attribute criterion may comprise a plurality of attribute criteria, and the data aggregation forming may comprise the data aggregator 40 identifying a data cluster by querying the received data with one of the attribute criteria, and using another one of the attribute criteria to extract statistical data from the data cluster. In this implementation, the attribute criteria used by the data aggregator 40 to extract statistical data from the data cluster may define a pre-defined weighting method or criterion for grouping or summing each type of data attribute. For example, in order to aggregate a population attribute for a geographic region represented in the database records produced by data aggregator 40, the data aggregator 40 may produce a sum of the number of people associated with each of the database records produced by the data aggregator 40. Alternatively, a pre-defined weighting criterion may allow the data aggregator 40 to produce an average or median value of a particular attribute on a per-household or per-individual basis.

In one implementation, the data aggregation forming may comprise the data aggregator 40 using the another of the attribute criteria in the first query to determine an average value on a per-household basis from the data cluster. In another implementation, the data aggregation forming may comprise the data aggregator 40 using the another of the attribute criteria in the first query to determine an average value on a per-individual basis from the data cluster. In another implementation, the data aggregation forming may comprise the data aggregator 40 using the another of the attribute criteria in the second query to determine an average value on a per-household basis from the data cluster. In another implementation, the data aggregation forming may comprise the data aggregator 40 using the another of the attribute criteria in the second query to determine an average value on a per-individual basis from the data cluster.

Where population is the attribute being aggregated, the data aggregator 40 could be configured to produce an average number of people per household within the geographic region. Similarly, the total number of households within the geographic region may also be determined by the data aggregator 40. In any of these cases, the data aggregator 40 may be querying the data produced by the data aggregator 40 with the data attribute criterion and the geographic criterion to produce aggregated data satisfying all of the search the criterion. If required by the selected pre-defined report template, the data aggregator 40 may manipulate the aggregated data by performing arithmetic operations upon the aggregated data as required.

If the selected pre-defined report template does not define a suitable pre-defined weighting criterion for aggregating a particular data attribute type, the data aggregator 40 may prompt the user of the computer system 20 to input such a weighting criterion, or read additional weighting criterion from a data source in memory 26, 28. Once the data aggregator 40 has completed aggregating the data produced by the data aggregator 40, the aggregated data may be stored in memory 26, 28, stored in a new database or written to a file in non-volatile memory 26.

Optionally, upon completion of step 5200, the aggregated data may be read by the conversion engine. In order to conduct the required analysis of the aggregated data, it may be required to convert the aggregated data into a different format. The conversion engine may have its own internal memory storage defining a required output data format for each input data format, or formatting requirements (also known as reporting requirements) may be provided to the conversion engine by the user or in a data source or file in memory 26, 28. For example, the conversion engine may be required to convert data attributes of the aggregated data into new values represented as a percentage of another attribute. Similarly, a percentage value could be converted to an index value by the conversion engine.

The conversion engine could also produce a new attribute by performing a summation or other arithmetic operation on one or more of the data attributes of the aggregated data records. For example, the aggregated data may include data attributes representing the magnitude of the population between the ages 10 and 14 in the geographic region defined by the geographic criterion 36, and the magnitude of the population between the ages 15 and 19 in the geographic region, respectively. The conversion engine could determine the magnitude of the population between the ages 10 and 19 in the geographic region by summing the values of these data attributes and storing the result in memory 26, 28, a database, or a new file in non-volatile memory 26.

The conversion engine may also sort the aggregated data records alphanumerically or by any other sorting method. The conversion engine may also scale or translate data attributes of the aggregated data records to fit within a particular number range by applying a scaling or translation matrix to the data attributes, thereby producing new data attributes. If the conversion engine creates a new data attribute, that data attribute may be saved to a new database in memory 26, 28, or appended to an existing database for further analysis. Aggregated data modified by the conversion engine may be identified as converted data. Optionally, the conversion engine may perform conversion operations on the results of step S100 for processing at S200 by the data aggregator 40. One example where this may occur may be where, prior to step S200, the conversion engine may convert geographic data read by the data aggregator 40 to a geographic format comprising latitude and longitude values. In this case, each said geographic data may comprise latitude and longitude values geographically covered by the respective geographic region defined by the respective first or second query. Alternatively, the data aggregator 40 or list engine may perform some or all of the described functions of the conversion engine.

At step S300, the computer system 20, and in particular the logic analyzer 42, performs an analysis of the data aggregations by applying a result of the first query and a result of the second query as inputs to a pre-defined logic function. The logic analyzer 42 then evaluates the logic function.

Either the aggregated data or the converted data may be read from memory 26, 28 and analyzed by the logic analyzer 42. The logic analyzer 42 may be configured to identify the pre-defined logic function pre-defined by the selected pre-defined report template and evaluate the logic function accordingly. Alternatively, the logic analyzer 42 may be presented with a pre-determined logic scenario from the selected pre-defined report template and identify the corresponding pre-defined logic function to be evaluated for use with the logic scenario. In this context, a logic scenario may be a statement describing conditions for displaying specific information in a report defined by the selected pre-defined report template. Pre-defined logic scenarios may be pre-programmed into memory of the logic analyzer 42 or contained in the selected pre-defined report template initially selected by the user. Each logic scenario may follow pre-defined steps based on the properties of each data attribute type being analyzed and the pre-determined requirements for displaying in the report.

The logic analyzer 42 may be configured to evaluate the logic function when the corresponding conditions of the logic scenario are met. The pre-defined logic scenario steps may be programmed into the logic analyzer 42 or selected pre-defined report template for evaluation by the logic analyzer 42 as a series of pre-defined if/else if logic or case statements. For example, a logic scenario might state that if the sum of selected data attributes of the aggregated data is greater than 70%, the logic analyzer 42 is to produce a pie chart showing those selected data attributes as percentage values. Optionally, the conversion engine may have previously converted the data attributes to percentage format, and the logic analyzer 42 may then produce a response containing a pie chart showing the respective percentage values of those data attributes. Responses generated by the logic analyzer 42 can be stored in memory 26, 28, saved in a database, or to a file in non-volatile memory 26.

In another example, the logic scenario might define that an image representing the most common style of house owned by consumers in a given geographical region shall be displayed. In this example, the corresponding logic function evaluated by the logic analyzer 42 may be a series of comparison statements to select an image to display from a selection of pre-defined possible images stored in memory 26, 28 or other data source.

In one implementation, the evaluating the logic function may comprise the logic analyzer 42 comparing the result of the first query to the result of the second query.

Accordingly, the logic analyzer 42 may compare query results in evaluating the logic function. In another embodiment, the logic function evaluating may comprise a compound operation involving several different logic operations, or comparisons, including comparing average customer house value, average baseline house value, average national house value, percentage of customer houses that are single detached houses, percentage of houses in the baseline comparison group that are single detached houses, and index value of the customers with a single detached house compared to the percentage of houses in the baseline comparison group with a single detached house. Depending on the result of the logic function evaluation, the logic analyzer 42 may produce a response containing a specific pre-defined image.

The logic processes may provide image responses according to data attribute criterion required by the selected pre-defined report template or by a particular user of the computer system 20. However, the logic analyzer 42 may not be intended to be modified by an end user of the computer system 20.

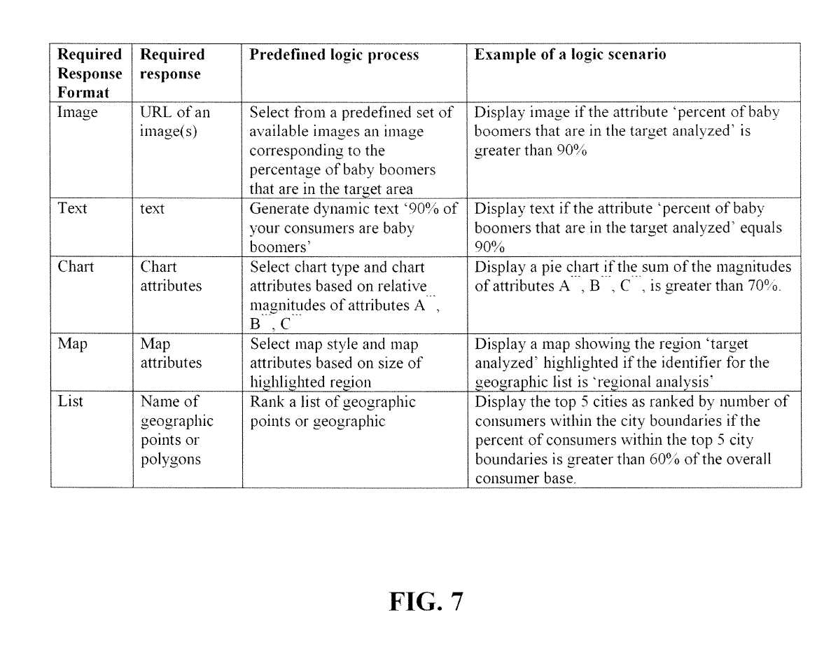

Possible types of logic responses produced by the logic engine evaluating the logic function include images, text, charts, maps, or lists. The logic engine may dynamically generate text or identify one or more attributes that satisfy a pre-defined logic scenario. Preferably, the evaluation of each logic function by the logic analyzer 42 produces an evaluation for human readability. For example, the result of the evaluation may result in human-readable text stating that households in a selected geographic region have a significantly high household income, above a predetermined threshold, meaning there is a high likelihood to purchase at least one particular type of product of at least one particular company amongst households in the selected geographic region. Some additional examples of logic scenarios are shown in FIG. 7.

The logic analyzer 42 may differ from existing tools which would require a user to manually interpret logic scenarios or display simple attribute information without interpretation.

At step S400, the computer 20, and in particular the report engine 44, generates a human-readable synopsis of the received data on the display device 38. The report engine 44 generates the human-readable synopsis by applying a result of the data aggregation analysis as an input to a pre-defined report template.

When the logic analyzer 42 has completed evaluating each logic function as required by the selected pre-defined report template, the logic analyzer 42 may transmit those responses to the report engine 44 or store those response in memory 26, 28, to be read by the report engine 44. The report engine 44 may display the responses in a report which may be outputted to the display device, saved to a file in memory 26, 28, or printed to a printer in communication with the computer system 20. The report engine 44 may be pre-configured with pre-defined report templates for displaying and formatting the data aggregation analysis. Alternatively, the report engine 44 may be configured by a user by selecting and placing pre-defined logic scenarios on the report, or the report engine 44 may read formatting instructions from memory 26, 28 or from a file stored in non-volatile memory 26. Accordingly, the applying the result of the data aggregation analysis as an input to the pre-defined report template may comprise the report engine 44 generating the human-readable synopsis depicting the result of the first query and the result of the second query.

In one implementation, the applying the result of the data aggregation analysis as an input to the pre-defined report template may comprise the report engine 44 generating the human-readable synopsis depicting the geographic region of the first query and the geographic region of the second query. Accordingly, the report may depict one or more maps showing geographic regions thereon. FIG. 6 shows a visual representation of a layout of a report 50 produced by the report engine 44. Each of the regions identified as 52, 54, 56, 58, and 60 requires a response of a logic function evaluation and may be populated with the evaluations produced by the logic analyzer 42 as directed by the selected pre-defined report template reporting requirements. Each of these regions of the report may have a pre-defined response data and layout format associated therewith, including image, text, map, list, or other format.

The computer system 20 may also be configured to allow a user to optionally upload and store a new geography file in memory 26, 28 without requesting that the computer system 20 generate a report. In this case, only the data aggregator 40 or list engine would execute, outputting the results to memory 26, 28, a database or file as previously described.

1. A method of generating a human-readable data synopsis, comprising:
a computer receiving data from a plurality of data sources comprising at least one of demographic data attributes and consumer behavioural data attributes, at least one of the data sources further comprising geographic data associated with the at least one of demographic data attributes and consumer behavioural data attributes;
the computer forming data aggregations by querying the received data with at least a first query and a second query, the first and second queries each including a common data attribute criterion and a respective geographic criterion, the data attribute criterion querying the at least one demographic and consumer behavioural data attributes, the geographic criteria querying the geographic data, the geographic criterion of the first query defining a different geographic region than the geographic criterion of the second query;
the computer performing an analysis of the data aggregations by applying a result of the first query and a result of the second query as inputs to a pre-defined logic function, and evaluating the logic function; and
on a display device the computer generating a human-readable synopsis of the received data by applying a result of the data aggregation analysis as an input to a pre-defined report template.

2. The method according to claim 1 wherein the common data attribute criterion comprises a plurality of attribute criteria, and the data aggregation forming comprises the computer identifying a data cluster by querying the received data with one of the attribute criteria, and using another one of the attribute criteria to extract statistical data from the data cluster.

3. The method according to claim 1 wherein the evaluating the logic function comprises the computer comparing the result of the first query to the result of the second query.

4. The method according to claim 1 wherein the applying the result of the data aggregation analysis as an input to the pre-defined report template comprises the computer generating the human-readable synopsis depicting the geographic region of the first query and the geographic region of the second query.

5. The method according to claim 4 wherein the applying the result of the data aggregation analysis as an input to the pre-defined report template comprises the computer generating the human-readable synopsis depicting the result of the first query and the result of the second query.

6. The method according to claim 1 wherein the geographic criterion associated with the second query comprises a subset of the geographic criterion associated with the first query.

7. The method according to claim 1 wherein the geographic criterion associated with the second query is entirely geographically distinct from the geographic criterion associated with the first query.

8. The method according to claim 1 wherein each of the geographic criteria comprises at least one of a pair of latitude and longitude co-ordinates, a pair of geographic point and radius distance, and a geographic polygon.

9. The method according to claim 8 wherein at least one of the geographic criteria comprises at least one geographic polygon defined by a maximum latitude, maximum longitude, minimum latitude, minimum longitude, centroid latitude, and centroid longitude.

10. The method according to claim 1 further comprising, prior to the data aggregations forming step, the computer converting the geographic data to a geographic format comprising latitude and longitude values.

11. The method according to claim 10 wherein each said geographic data comprises latitude and longitude values geographically covered by the respective geographic region.

12. The method according to claim 2 wherein the data aggregation forming comprises the computer using the another of the attribute criteria in the first query to determine an average value on a per-household basis from the data cluster.

13. The method according to claim 2 wherein the data aggregation forming comprises the computer using the another of the attribute criteria in the first query to determine an average value on a per-individual basis from the data cluster.

14. The method according to claim 2 wherein the data aggregation forming comprises the computer using the another of the attribute criteria in the second query to determine an average value on a per-household basis from the data cluster.

15. The method according to claim 2 wherein the data aggregation forming comprises the computer using the another of the attribute criteria in the second query to determine an average value on a per-individual basis from the data cluster.

16. A computer-readable medium containing a set of computer processing instructions stored thereon, that when executed by a computer causes the computer to implement the method of claim 1.

17. A computer system comprising a computer in communication with a display device, the computer system comprising:
a data aggregator configured to receive from a plurality of data sources data comprising at least one of demographic data attributes and consumer behavioural data attributes, and to form data aggregations by querying the received data with at least a first query and a second query, at least one of the data sources further comprising geographic data associated with the at least one of demographic data attributes and consumer behavioural data attributes, the first and second queries each including a common data attribute criterion and a respective geographic criterion, the data attribute criterion querying the at least one demographic and consumer behavioural data attributes, the geographic criteria querying the geographic data, the geographic criterion of the first query defining a different geographic region than the geographic criterion of the second query;
a logic analyzer configured to perform an analysis of the data aggregations by applying a result of the first query and a result of the second query as inputs to a pre-defined logic function, and evaluating the logic function; and
a report engine configured to generate and display on the display device a human-readable synopsis of the received data by applying a result of the data aggregation analysis as an input to a pre-defined report template.
